(19) United States
(12) Patent Application Publication
(10) Pub. No.: US 2026/0029307 A1
(43) Pub. Date: Jan. 29, 2026

(54) ROLLING-BEARING REPLACEMENT-TIMING PREDICTION METHOD AND ROLLING-BEARING REPLACEMENT-TIMING PREDICTION DEVICE

(71) Applicant: KABUSHIKI KAISHA KOBE SEIKO SHO (KOBE STEEL, LTD.), Hyogo (JP)

(72) Inventors: Toru OKADA, Kobe-shi (JP); Kazuo YAMAGUCHI, Takasago-shi (JP)

(73) Assignee: KABUSHIKI KAISHA KOBE SEIKO SHO (KOBE STEEL, LTD.), Hyogo (JP)

(21) Appl. No.: 19/248,426

(22) Filed: Jun. 24, 2025

(30) Foreign Application Priority Data
Jul. 23, 2024 (JP) 2024-117730

(51) Int. Cl. G01M 13/045; G01H 1/00

(52) U.S. Cl. CPC G01M 13/045; G01H 1/003

(57) ABSTRACT

The present disclosure provides a rolling-bearing replacement-timing prediction device and method enabling a more accurate replacement-timing prediction. A frequency spectrum of vibration data indicating vibration of a rolling bearing is determined for every sampling period and is stored in association with the sampling period into a storage unit. A specific peak not appearing during a normal state is detected from the frequency spectrum within a first frequency range including a theoretical frequency at which a peak occurs during an abnormality. When the specific peak is detected, a specific peak is detected as a re-detection specific peak within a second frequency range, which includes the specific peak and is smaller than the first frequency range, from at least one frequency spectrum stored in the storage unit prior to this sampling period, and the replacement timing of the rolling bearing is predicted based on the specific peak and the re-detection specific peak.

### BACKGROUND OF THE INVENTION

### 1. Field of the Invention

The present invention relates to rolling-bearing replacement-timing prediction methods and rolling-bearing replacement-timing prediction devices for predicting replacement timings of rolling bearings.

### 2. Description of the Related Art

A rolling bearing supports a load by having rolling bodies, such as balls or rollers, placed between two members (i.e., a shaft and a bearing race), and is included in a device that is used for various purposes and that is equipped with a rotating body. With regard to such a rolling bearing, for example, smooth rolling thereof may be inhibited due to an abnormality, such as wear (abrasion or scratch), deformation-induced fatigue, or pressure-induced fusion, possibly leading to, for example, a failure in the device. Therefore, it is desirable to predict the replacement timing of the rolling bearing by predicting the remaining lifespan thereof. For example, Japanese Unexamined Utility Model Registration Application Publication No. H02-140451 discloses a rolling-bearing abnormality detector that predicts the remaining lifespan of a rolling bearing.

The rolling-bearing abnormality detector disclosed in Japanese Unexamined Utility Model Registration Application Publication No. H02-140451 includes a vibration sensor that detects a vibration frequency of a rolling bearing, a band-pass filter that allows an output signal from the vibration sensor to pass through based on band-pass characteristics selected in accordance with a contact frequency, among an inner ring, an outer ring, and balls, calculated based on a geometrical size of the bearing to be measured, a converter that performs frequency conversion on a time-domain signal from the filter, and a computational unit that calculates a spectral intensity corresponding to the contact frequency based on an output signal from the converter and computes a degradation index of each of the inner ring, the outer ring and the balls from a ratio between the calculated value and a reference spectral intensity. The rolling-bearing abnormality detector stores a temporal increase in the calculated spectral intensity and predicts a remaining lifespan of the rolling bearing from the rate of increase.

### SUMMARY OF THE INVENTION

The rolling-bearing abnormality detector disclosed in Japanese Unexamined Utility Model Registration Application Publication No. H02-140451 calculates the spectral intensity based on the contact frequency, among the inner ring, the outer ring, and the balls, calculated based on the geometrical size, that is, based on a theoretical frequency that brings about a peak in a frequency spectrum when an abnormality occurs, and detects the abnormality and predicts the remaining lifespan based on this calculated spectral intensity. However, in actuality, a peak does not necessarily occur at the theoretical frequency when an abnormality occurs. A peak may sometimes occur at a frequency deviated from the theoretical frequency. In such a case, even if the spectral intensity is calculated based on the set theoretical frequency, a peak occurring when an abnormality occurs cannot be detected, possibly making it difficult to predict the remaining lifespan. Japanese Unexamined Utility Model Registration Application Publication No. H02-140451 mentioned above does not have any indication about the relationship between the rate of increase in the spectral intensity and the remaining lifespan, so that it is unknown how the remaining lifespan is estimated from the rate of increase in the spectral intensity. Therefore, there is room for improvement in the prediction of the remaining lifespan, that is, the prediction of the replacement timing, disclosed in Japanese Unexamined Utility Model Registration Application Publication No. H02-140451.

The present disclosure has been made in view of the circumstances mentioned above, and an object thereof is to provide a rolling-bearing replacement-timing prediction method and a rolling-bearing replacement-timing prediction device that enable a more accurate prediction of the replacement timing of a rolling bearing.

As a result of various studies, the present inventor has found that the above object is achievable in accordance with the present disclosure described below. Specifically, a rolling-bearing replacement-timing prediction method according to an aspect of the present disclosure includes: a spectrum processing step for acquiring vibration data, which indicates vibration occurring in a rolling bearing, in a predetermined sampling period at every predetermined acquisition interval, determining a frequency spectrum of the vibration data in the sampling period with respect to the vibration data, and storing the determined frequency spectrum in association with the sampling period into a storage unit; a peak detection step for detecting, from the frequency spectrum, a specific peak not appearing during a normal state of the rolling bearing within a predetermined first frequency range including a theoretical frequency that brings about a peak in the frequency spectrum when an abnormality occurs; a peak re-detection step for detecting, if the specific peak is detected in the peak detection step, a specific peak not appearing during the normal state of the rolling bearing as a re-detection specific peak within a predetermined second frequency range from at least one frequency spectrum stored in the storage unit prior to a sampling period when the specific peak is detected, the predetermined second frequency range including a frequency of the specific peak detected in the peak detection step and being smaller than the first frequency range; and a replacement-timing prediction step for predicting a replacement timing of the rolling bearing based on the sampling period when the specific peak is detected in the peak detection step as well as an amplitude of the detected specific peak, and based on a sampling period when the re-detection specific peak is detected in the peak re-detection step as well as an amplitude of the detected re-detection specific peak. Preferably, in a coordinate space having time and amplitude set as coordinate axes, the replacement-timing prediction step in the aforementioned rolling-bearing replacement-timing prediction method may include determining a fitting curve that most fits a central time point of the sampling period when the specific peak is detected in the peak detection step and the amplitude of the detected specific peak as well as a central time point of the sampling period when the re-detection specific peak is detected in the peak re-detection step and the amplitude of the detected re-detection specific peak, and determining a time point, as a replacement timing, where the determined fitting curve intersects a preset criterion amplitude value used for determining the replacement timing. Preferably, in the aforementioned rolling-bearing replacement-timing prediction method, the first frequency range may be set such that the theoretical frequency is the median frequency.

Normally, when some kind of failure that inhibits smooth rolling occurs in the rolling bearing in the normal state, a peak becomes determinable after the amplitude of the peak becomes large with the progress of the failure, so that the frequency of the peak can be identified. On the other hand, it is assumed that a peak prior to being identified occurs in the vicinity of the identified frequency. In the rolling-bearing replacement-timing prediction method, a specific peak is detected within the first frequency range including the theoretical frequency, so that the specific peak can be detected more reliably. A specific peak is re-detected by narrowing down to the second frequency range that is smaller than the first frequency range, so that a misleading peak that is included in the first frequency range but does not cause the failure to occur is excluded from a detection target, thereby enabling more reliable detection of a specific peak that causes the failure to occur.

On the other hand, after a peak is identified, a remaining lifespan as a time period until the rolling bearing needs to be replaced ((end point of a sampling period corresponding to a frequency spectrum (vibration data) in which the specific peak is detected)+(remaining lifespan at that time)=(replacement timing)) is dependent on the progress (i.e., temporal change or trend) of the failure. When the failure progresses relatively slowly, the remaining lifespan is relatively long. In contrast, when the failure progresses relatively quickly, the remaining lifespan is relatively short. The aforementioned rolling-bearing replacement-timing prediction method involves not only detecting a specific peak but also a re-detection specific peak prior thereto, and predicting the replacement timing based on the sampling period when the specific peak is detected in the peak detection step as well as the amplitude of the detected specific peak, and based on the sampling period when the re-detection specific peak is detected in the peak re-detection step as well as the amplitude of the detected re-detection specific peak, so that the replacement timing is predicted in view of the progress of the failure, whereby the replacement timing can be predicted more accurately. Furthermore, in the aforementioned rolling-bearing replacement-timing prediction method, if the replacement timing is predicted by using multiple re-detection specific peaks, the replacement timing can be predicted more accurately, as compared with a case where the replacement timing is predicted by using a single re-detection specific peak.

In the rolling-bearing replacement-timing prediction method according to the above aspect, the at least one frequency spectrum may include a plurality of frequency spectra, and the peak re-detection step may include, when detecting the re-detection specific peak in a past direction from the plurality of frequency spectra, regarding the peak detection step and the specific peak detected in the peak detection step with respect to each frequency spectrum as a first peak re-detection step and a first re-detection specific peak, respectively, and detecting, from the frequency spectrum, the re-detection specific peak within the second frequency range including a re-detection specific peak detected in one previous peak re-detection step. Preferably, in the aforementioned rolling-bearing replacement-timing prediction method, the second frequency range may be set such that the frequency of the re-detection specific peak is the median frequency. Preferably, in the aforementioned rolling-bearing replacement-timing prediction method, the peak re-detection step may include detecting the re-detection specific peak sequentially and consecutively toward the past from the multiple frequency spectra. Preferably, in the aforementioned rolling-bearing replacement-timing prediction method, the peak re-detection step may include detecting the re-detection specific peak non-consecutively toward the past from the multiple frequency spectra.

In this rolling-bearing replacement-timing prediction method, the re-detection specific peak is detected within the second frequency range including a re-detection specific peak detected in one previous peak re-detection step, so that the re-detection specific peak can be detected more reliably even when the frequency of the re-detection specific peak changes with time.

In the rolling-bearing replacement-timing prediction method according to the above aspect, the peak detection step may further include detecting the specific peak within the second frequency range, which includes a specific peak detected in one previous peak detection step of the sampling period, from the frequency spectrum stored in the storage unit in the sampling period for every sampling period subsequent to the sampling period when the specific peak is detected.

In this rolling-bearing replacement-timing prediction method, the specific peak is detected within the second frequency range including a specific peak detected in one previous peak detection step, so that the specific peak can be detected more reliably after the detection even when the frequency of the specific peak changes with time after the detection.

In the rolling-bearing replacement-timing prediction method according to the above aspect, a duration of the sampling period may be set based on the second frequency range, and the sampling period may be set to a longer period as the second frequency range becomes smaller.

In this rolling-bearing replacement-timing prediction method, a peak can be detected from frequency spectrum data based on favorable frequency resolution according to the second frequency range.

A rolling-bearing replacement-timing prediction device according to another aspect of the present disclosure includes: a vibration detection sensor that acquires vibration data indicating vibration occurring in a rolling bearing; a storage unit; and a control processor that performs spectrum processing, a peak detection process, a peak re-detection process, and a replacement-timing prediction process. The spectrum processing includes acquiring the vibration data in a predetermined sampling period at every predetermined acquisition interval, determining a frequency spectrum of the vibration data in the sampling period with respect to the vibration data in the sampling period, and storing the determined frequency spectrum in association with the sampling period into the storage unit. The peak detection process includes detecting, from the frequency spectrum, a specific peak not appearing during a normal state of the rolling bearing within a predetermined first frequency range including a theoretical frequency that brings about a peak in the frequency spectrum when an abnormality occurs. The peak re-detection process includes, if the specific peak is detected in the peak detection process, detecting a specific peak not appearing during the normal state of the rolling bearing as a re-detection specific peak within a predetermined second frequency range from at least one frequency spectrum stored in the storage unit prior to a sampling period when the specific peak is detected, the predetermined second frequency range including a frequency of the specific peak detected in the peak detection process and being smaller than the first frequency range. The replacement-timing prediction process includes predicting a replacement timing of the rolling bearing based on the sampling period when the specific peak is detected in the peak detection process as well as an amplitude of the detected specific peak, and based on a sampling period when the re-detection specific peak is detected in the peak re-detection process as well as an amplitude of the detected re-detection specific peak.

This rolling-bearing replacement-timing prediction device can predict the replacement timing of the rolling bearing more accurately.

In the rolling-bearing replacement-timing prediction method and the rolling-bearing replacement-timing prediction device according to the present disclosure, a specific peak is detected within the first frequency range including the theoretical frequency, so that the specific peak can be detected more reliably. A specific peak is re-detected by narrowing down to the second frequency range that is smaller than the first frequency range, so that a misleading peak that is included in the first frequency range but does not cause a failure inhibiting smooth rolling of the rolling bearing is excluded from a detection target, thereby enabling more accurate detection of a specific peak. In the rolling-bearing replacement-timing prediction method and the rolling-bearing replacement-timing prediction device described above, not only a specific peak but also a re-detection specific peak prior thereto are detected, and the replacement timing is predicted based on the sampling period when the specific peak is detected as well as the amplitude of the detected specific peak, and based on the sampling period when the re-detection specific peak is detected as well as the amplitude of the detected re-detection specific peak, so that the replacement timing is predicted in view of the progress of the failure, whereby the replacement timing can be predicted more accurately.

### BRIEF DESCRIPTION OF THE DRAWINGS

FIG. 1 is a block diagram illustrating the configuration of a rolling-bearing replacement-timing prediction device according to an embodiment;

FIG. 2 is a diagram for explaining a predetermined time length in vibration data;

FIG. 3 is a diagram for explaining mechanical equipment equipped with a rolling bearing;

FIGS. 4A and 4B are diagrams for explaining first and second frequency ranges;

FIG. 5 illustrates how a replacement timing is predicted;

FIG. 6 is a flowchart illustrating the operation of the rolling-bearing replacement-timing prediction device before detecting a specific peak;

FIG. 7 is a flowchart illustrating the operation of the rolling-bearing replacement-timing prediction device after detecting the specific peak; and

FIG. 8 is a block diagram illustrating the configuration of a rolling-bearing replacement-timing prediction device according to a modification of the embodiment.

### DESCRIPTION OF THE PREFERRED EMBODIMENTS

One or more embodiments of the present disclosure will be described below with reference to the drawings. However, the scope of the invention is not limited to the disclosed one or more embodiments. In the drawings, components given the same reference sign indicate that they have the same configuration, and descriptions thereof will be omitted, where appropriate. In this description, when components are referred to collectively, such components are indicated using reference signs without subscripts, whereas when components are referred to individually, such components are indicated using reference signs with subscripts.

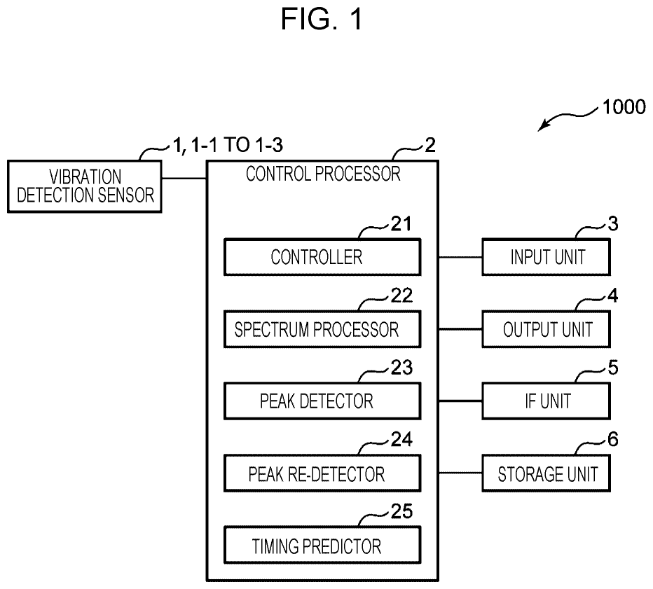

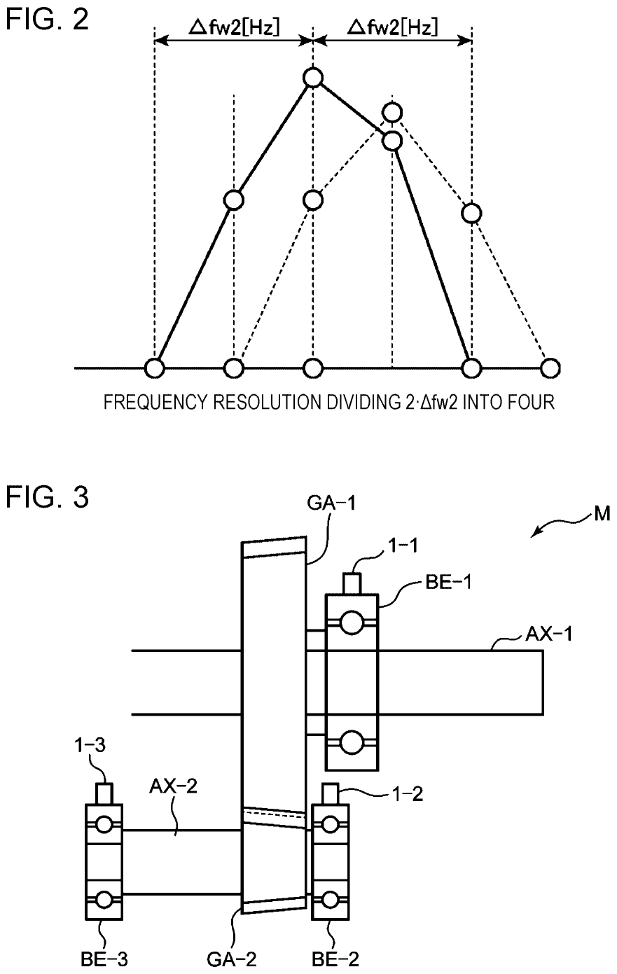

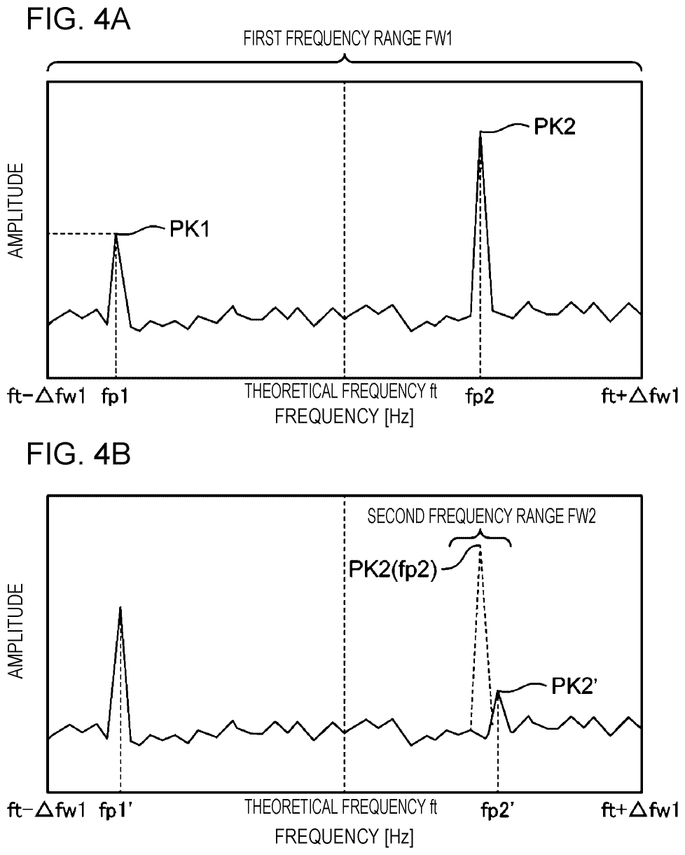

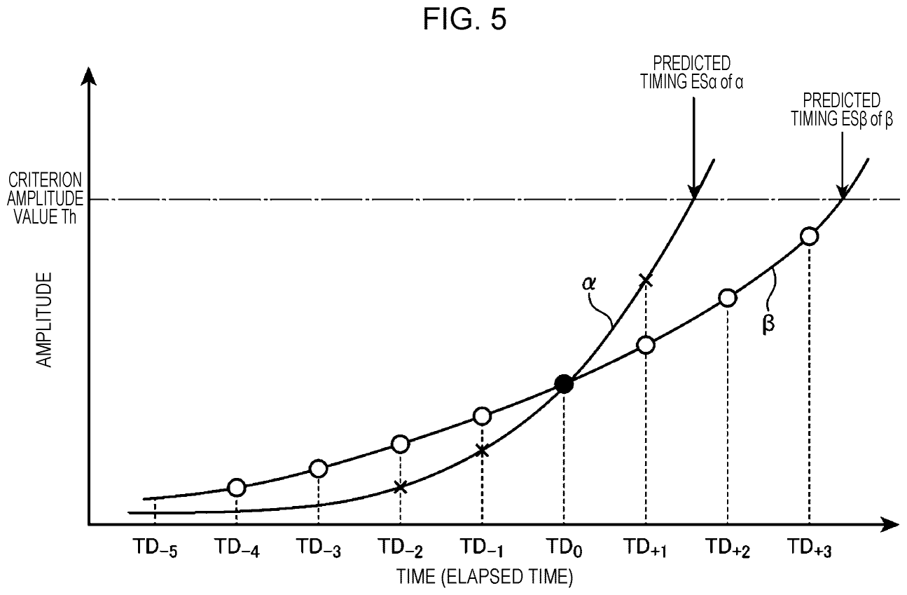

FIG. 1 is a block diagram illustrating the configuration of a rolling-bearing replacement-timing prediction device according to an embodiment. FIG. 2 is a diagram for explaining a predetermined time length in vibration data. FIG. 3 is a diagram for explaining mechanical equipment equipped with a rolling bearing. FIGS. 4A and 4B are diagrams for explaining first and second frequency ranges. FIG. 4A illustrates the first frequency range, and FIG. 4B illustrates the second frequency range. In each of FIG. 4A and FIG. 4B, the abscissa axis denotes the frequency [Hz], whereas the ordinate axis denotes the amplitude. FIG. 5 illustrates how a replacement timing is predicted. In FIG. 5, the abscissa axis denotes time (elapsed time), whereas the ordinate axis denotes amplitude.

For example, as shown in FIG. 1, a rolling-bearing replacement-timing prediction device 1000 according to the embodiment includes a vibration detection sensor 1, a control processor 2, an input unit 3, an output unit 4, an interface unit (IF unit) 5, and a storage unit 6.

The vibration detection sensor 1 is connected to the control processor 2 and acquires vibration data indicating vibration occurring in the rolling bearing in accordance with control by the control processor 2. In this embodiment, multiple pieces of vibration data acquired in a predetermined sampling period at every predetermined acquisition interval are stored in the storage unit 6 by the vibration detection sensor 1 that detects the vibration occurring in the rolling bearing.

As will be described later, the vibration data is converted from a time domain to a frequency domain by fast Fourier transform. In this case, the frequency resolution of a frequency spectrum is dependent on the number of data points used during the fast Fourier transform. The frequency resolution increases with increasing number of data points, and the vibration data in the predetermined sampling period is required accordingly. Assuming that a sampling interval is defined as SP, the number of data points is defined as Nfft, and the duration of the predetermined sampling period is defined as TW, TW=SP×Nfft. In this embodiment, the duration TW of the predetermined sampling period is set based on a second frequency range FW2, to be described later. The sampling period is set to a longer period as the second frequency range becomes smaller. In order to detect a significant peak in a second frequency range ±Δfw2, for example, the second frequency range ±Δfw2 (=2×Δfw2) needs to be divided into four or more segments, as shown in FIG. 2. Therefore, the frequency resolution becomes 2×Δfw2/4=Δfw2/2 [Hz] or more. Thus, the duration TW of the predetermined sampling period is a reciprocal thereof, which is 2/Δfw2 [s] or more. For example, if Δfw2 is set to 0.02 [Hz] and the sampling interval SP is set to 0.2 [ms] (=0.0002 [s]), the duration TW of the predetermined sampling period is TW=2/0.02=100 [s] or more, and the number Nfft of data points is Nfft=100/0.0002=500,000 [data points] or more. Since fast Fourier transform normally treats a power of 2, a minimum number exceeding 500,000 [data points] is 2∧19=524, 288 [data points], and the duration TW of the predetermined sampling period is TW=0.0002×524, 288=104.8576 [s].

The vibration detection sensor 1 includes one or more sensors disposed in a device, such as the mechanical equipment, equipped with a rolling bearing to be monitored. The mechanical equipment is an example of a device equipped with a rolling bearing, and may be any equipment so long as it is equipped with a rolling bearing. For example, mechanical equipment M mentioned above is a speed reducer M shown in FIG. 3 and generally includes first to third rolling bearings BE-1 to BE-3, first and second rotation shafts AX-1 and AX-2, first and second gears GA-1 and GA-2, and a housing (not shown) that accommodates the first to third rolling bearings BE-1 to BE-3, the first and second rotation shafts AX-1 and AX-2, and the first and second gears GA-1 and GA-2. The first rotation shaft AX-1 is fixed to the first gear GA-1, serves as a rotation shaft for the first gear GA-1, and is supported by the first rolling bearing BE-1. The second rotation shaft AX-2 is fixed to the second gear GA-2, serves as a rotation shaft for the second gear GA-2, and is supported by the second and third rolling bearings BE-2 and BE-3. The first gear GA-1 and the second gear GA-2 mesh with each other. For example, a rotational force occurring from rotation of the first rotation shaft AX-1 is transmitted to the second rotation shaft AX-2 via the first and second gears GA-1 and GA-2, whereby the second rotation shaft AX-2 rotates.

For the speed reducer M having such a configuration, the vibration detection sensor 1 includes three vibration detection sensors, namely, first to third vibration detection sensors 1-1 to 1-3. The first to third vibration detection sensors 1-1 to 1-3 are respectively disposed on the outer peripheries of the first to third rolling bearings BE-1 to BE-3. The vibration detection sensors 1 (1-1 to 1-3) are not limited to being disposed on the respective rolling bearings BE, and may be disposed in, for example, the housing. The point is that the first to third vibration detection sensors 1-1 to 1-3 are disposed in areas that receive the vibration caused by the rolling bearings BE. The first to third vibration detection sensors 1-1 to 1-3 are, for example, acceleration sensors or acoustic emission (AE) sensors, and may be appropriate sensors used in accordance with the frequency of the vibration occurring in the target to be monitored. In this embodiment, each of the first to third vibration detection sensors 1-1 to 1-3 outputs a detection result to the control processor 2.

In this embodiment, for example, when a start timing of the predetermined sampling period is reached, the control processor 2 commands the first to third vibration detection sensors 1-1 to 1-3 to acquire the vibration data. In response to this command, each of the first to third vibration detection sensors 1-1 to 1-3 detects vibration at a corresponding sampling timing according to the predetermined sampling interval, and outputs the vibration data in the duration TW of the predetermined sampling period to the control processor 2. The control processor 2 stores the vibration data and the sampling period (e.g., the start timing of the sampling period) in association with each other into the storage unit 6.

The input unit 3 is connected to the control processor 2 and, for example, inputs, to the rolling-bearing replacement-timing prediction device 1000, various types of commands, such as a command for starting a prediction of a replacement timing, and various types of data, such as the name of the mechanical equipment to be monitored, required for actuating the rolling-bearing replacement-timing prediction device 1000. For example, the input unit 3 includes multiple input switches to which predetermined functions are assigned, a keyboard, and/or a mouse. The output unit 4 is connected to the control processor 2 and outputs commands and data input from the input unit 3 as well as, for example, a replacement timing in accordance with control by the control processor 2. Examples of the output unit 4 include a display device, such as a cathode-ray tube (CRT) display, a liquid crystal display, or an organic electroluminescent (EL) display, and a printing device, such as a printer.

The input unit 3 and the output unit 4 may constitute a so-called touchscreen. In the case where such a touchscreen is provided, the input unit 3 serves as, for example, a resistive or capacitive position input device that detects and receives an operational position, and the output unit 4 serves as a display device. In this touchscreen, the position input device is provided on a display surface of the display device and displays one or more inputtable candidates on the display device. When a user touches a display position corresponding to a desired inputtable candidate, the position input device detects the position, and the display content displayed at the detected position is input as user's operational input content to the rolling-bearing replacement-timing prediction device 1000. Since such a touchscreen allows the user to intuitively comprehend the input operation readily, a user-friendly rolling-bearing replacement-timing prediction device 1000 can be provided.

The IF unit 5 is a circuit that is connected to the control processor 2 and that receives and outputs data to and from an external device in accordance with control by the control processor 2. Examples of the circuit include an RS-232C interface circuit of a serial communication type, an interface circuit using the Bluetooth (registered trademark) standard, an interface circuit of the infrared data association (IrDA) standard that performs infrared communication, and an interface circuit using the universal serial bus (USB) standard. The IF unit 5 may also be a circuit that communicates with an external device. Examples of the circuit include a data communication card and a communication interface circuit according to the IEEE 802.11 standard.

The storage unit 6 is a circuit that is connected to the control processor 2 and that stores various types of predetermined programs and various types of predetermined data in accordance with control by the control processor 2. The various types of predetermined programs include, for example, a control processing program. Examples of the control processing program include a control program, a spectrum processing program, a peak detection program, a peak re-detection program, and a replacement-timing prediction program. The control program involves controlling the components 1 and 3 to 6 of the rolling-bearing replacement-timing prediction device 1000 in accordance with the functions of the respective components. The spectrum processing program involves causing the vibration detection sensor 1 to acquire multiple different pieces of vibration data in multiple different sampling periods, determining frequency spectra of the vibration data in the sampling periods with respect to the respective multiple sampling periods, and storing the determined frequency spectra in association with the respective sampling periods into the storage unit 6. The peak detection program involves detecting, from each frequency spectrum, a specific peak not appearing during a normal state of a rolling bearing within a predetermined first frequency range including a theoretical frequency that brings about a peak in the frequency spectrum when an abnormality occurs. The peak re-detection program involves, when a specific peak is detected in the peak detection program, detecting a specific peak not appearing during the normal state of the rolling bearing as a re-detection specific peak within a predetermined second frequency range, which is smaller than the first frequency range and includes the frequency of the specific peak detected in the peak detection program, from at least one frequency spectrum stored in the storage unit 6 prior to the sampling period when the specific peak is detected. The replacement-timing prediction program involves predicting a replacement timing of the rolling bearing based on the sampling period when the specific peak is detected in the peak detection program as well as the amplitude of the detected specific peak, and based on the sampling period when the re-detection specific peak is detected in the peak re-detection program as well as the amplitude of the detected re-detection specific peak. The various types of predetermined data include, for example, data required for executing the respective programs, such as the frequency spectrum associated with the sampling period, the theoretical frequency, the first frequency range, the second frequency range, the specific peak, the re-detection specific peak, and the predicted replacement timing. The storage unit 6 includes, for example, a read-only memory (ROM) serving as a nonvolatile storage element and an electronically erasable and programmable read-only memory (EEPROM) serving as a rewritable nonvolatile storage element. The storage unit 6 also includes a random access memory (RAM) that serves as a so-called working memory for the control processor 2 and that stores, for example, data generated during execution of the predetermined programs. The storage unit 6 may also include a hard disk drive or a solid state drive (SSD) capable of storing a relatively large volume of data.

The control processor 2 is a circuit for controlling the components 1 and 3 to 6 of the rolling-bearing replacement-timing prediction device 1000 in accordance with the functions of the respective components, and for predicting the replacement timing of each rolling bearing BE. For example, the control processor 2 includes a central processing unit (CPU) and a peripheral circuit thereof. The control processor 2 executes the control processing program to functionally serve as a controller 21, a spectrum processor 22, a peak detector 23, a peak re-detector 24, and a timing predictor 25.

The controller 21 controls the components 1 and 3 to 6 of the rolling-bearing replacement-timing prediction device 1000 in accordance with the functions of the respective components, and is responsible for controlling the entire rolling-bearing replacement-timing prediction device 1000.

The spectrum processor 22 executes spectrum processing involving causing the vibration detection sensor 1 to acquire vibration data in each of multiple different sampling periods. The spectrum processing involves determining a frequency spectrum of the vibration data in each of the multiple sampling periods and storing the determined frequency spectrum in association with the sampling period into the storage unit 6. In more detail, in the spectrum processing, when a start timing of a sampling period of a preset acquisition interval is reached, vibration data in the duration TW of the predetermined sampling period is acquired by each of the first to third vibration detection sensors 1-1 to 1-3, is stored in the storage unit 6, and is acquired as vibration data of the current sampling period by the spectrum processor 22. Then, the spectrum processor 22 converts time-domain vibration data acquired by the first vibration detection sensor 1-1 into frequency-domain vibration data by, for example, fast Fourier transform (FFT) so as to determine the frequency spectrum of the vibration data, and stores the frequency spectrum of the vibration data in association with the sampling period and the first vibration detection sensor 1-1 (e.g., an identifier (sensor ID) of the first vibration detection sensor 1-1) into the storage unit 6. Subsequently, the spectrum processor 22 similarly converts time-domain vibration data acquired by the second vibration detection sensor 1-2 into frequency-domain vibration data by FFT so as to determine the frequency spectrum of the vibration data, and stores the frequency spectrum of the vibration data in association with the sampling period and the second vibration detection sensor 1-2 (e.g., an identifier (sensor ID) of the second vibration detection sensor 1-2) into the storage unit 6. Likewise, the spectrum processor 22 converts time-domain vibration data acquired by the third vibration detection sensor 1-3 into frequency-domain vibration data by FFT so as to determine the frequency spectrum of the vibration data, and stores the frequency spectrum of the vibration data in association with the sampling period and the third vibration detection sensor 1-3 (e.g., an identifier (sensor ID) of the third vibration detection sensor 1-3) into the storage unit 6. This processing is repeatedly executed at the start timing of the sampling period of the preset acquisition interval. The acquisition interval is appropriately set in advance in accordance with, for example, a target for which an abnormality is to be detected. Since the lifespan of a rolling bearing can be predicted from, for example, load and rotation speed, the acquisition interval can be appropriately set in accordance with the lifespan of the rolling bearing. For example, if the target to be monitored is a rolling bearing for receiving a shaft that is used relatively heavily, such as a constantly operating shaft rotating at high speed, the acquisition interval is set to a relatively short time length, such as one hour or one day. For example, if the target to be monitored is a rolling bearing for receiving a shaft that is used relatively lightly, such as a shaft rotating relatively gently, the acquisition interval is set to a relatively long time length, such as one month or six months. The start timing of the sampling period is expressed with, for example, a consecutive number from the start of acquisition of the vibration data or a time point of the start timing.

When the frequency spectrum is to be stored into the storage unit 6, the peak detector 23 executes a peak detection process involving detecting, from the frequency spectrum, a specific peak not appearing during the normal state of the rolling bearing within the predetermined first frequency range including the theoretical frequency that brings about a peak in the frequency spectrum when an abnormality occurs. When detecting the specific peak, the peak detector 23 stores the sampling period, amplitude, and frequency of the detected specific peak into the storage unit 6.

A theoretical frequency ft mentioned above that brings about a peak in a frequency spectrum when an abnormality occurs is widely known and varies depending on an area where a damage (bearing damage) occurs in the rolling bearing. For example, the theoretical frequency ft is as indicated in Table 1 below. Examples of the area of the bearing damage include an inner ring, an outer ring, a rolling body, and a retainer. In this case, fti denotes the theoretical frequency when a bearing damage occurs in the inner ring, fto denotes the theoretical frequency when a bearing damage occurs in the outer ring, ftb denotes the theoretical frequency when a bearing damage occurs in a rolling body, and ftm denotes the theoretical frequency when a bearing damage occurs in the retainer. Moreover, d denotes the diameter of each rolling body, D denotes the pitch circle diameter of each rolling body, Z denotes the number of rolling bodies, and a denotes a contact angle.

TABLE 1

| AREA OF BEARING DAMAGE | THEORETICAL FREQUENCY fₜ |
|---|---|
| INNER RING fₜᵢ | $\frac{{Zf}_{0}}{2} ( 1 + \frac{d}{D} cos a )$ |
| OUTER RING fₜₒ | $\frac{{Zf}_{0}}{2} ( 1 - \frac{d}{D} cos α )$ |
| ROLLING BODY f_{tb} | $\frac{{f}_{0} D}{2 d} \{ 1 - {( \frac{d}{D} )}^{2} {cos}^{2} α \}$ |
| RETAINER fₜₘ | $\frac{{f}_{0}}{2} ( 1 - \frac{d}{D} cos a )$ |

The frequency of the peak occurring in the frequency spectrum due to the occurrence of some kind of failure that inhibits smooth rolling of the rolling bearing in the normal state (e.g., an unused rolling bearing) does not actually match the theoretical frequency due to, for example, dimensional tolerance or load-induced deformation of the rolling bearing. Therefore, in order to detect an unknown peak occurring in the frequency spectrum, a predetermined first frequency range including the theoretical frequency ft is appropriately set in advance. For example, as shown in FIG. 4A, a first frequency range FW1 is set such that the theoretical frequency ft is the median frequency (ft−Δfw1≤FW1≤ft+Δfw1, Δfw1 being, for example, about 1% to 5% of ft).

When detecting a specific peak not appearing during the normal state of the rolling bearing (i.e., a peak appearing due to the aforementioned failure), for example, if a peak is detected in the first frequency range FW1 and a peak (harmonic wave) also exists at a frequency corresponding to an integral multiple of (e.g., twice or three times) the frequency of the detected peak, it is determined that the detected peak is a specific peak and that the specific peak is detected. If there is no peak at the frequency corresponding to the integral multiple of the frequency of the detected peak, it is determined that the detected peak is not a specific peak and that the specific peak is not detected. For example, in FIG. 4A, a peak PK1 and a peak PK2 are detected in the first frequency range FW1, and there is no peak at a frequency corresponding to an integral multiple, which is a characteristic of bearing damage vibration, of a frequency fp1 of the peak PK1. On the other hand, if there is a peak at a frequency corresponding to an integral multiple of a frequency fp2 of the peak PK2, it is determined that the peak PK1 is not a specific peak, whereas it is determined that the peak PK2 is a specific peak and that the specific peak is detected. In this embodiment, the plurality of first to third vibration detection sensors 1-1 to 1-3 are used, so that if a specific peak is detected at a common frequency in at least two frequency spectra among the first to third vibration detection sensors 1-1 to 1-3, it is ultimately determined that the specific peak is detected.

If a specific peak is detected by the peak detector 23, the peak re-detector 24 executes a peak re-detection process involving detecting a specific peak not appearing during the normal state as a re-detection specific peak within a predetermined second frequency range FW2, which is smaller than the first frequency range FW1 and includes the frequency of the specific peak detected by the peak detector 23, from at least one frequency spectrum stored in the storage unit 6 prior to the sampling period when the specific peak is detected. The peak re-detector 24 stores the sampling period, the amplitude, and the frequency of the detected re-detection specific peak into the storage unit 6.

In order to detect the progress (i.e., temporal change or trend) of the failure, the peak re-detector 24 may detect, as a re-detection specific peak, a specific peak from one frequency spectrum stored in the storage unit 6 prior to the sampling period of the frequency spectrum from which the specific peak is detected by the peak detector 23, or may detect, as a re-detection specific peak, a specific peak from several frequency spectra (multiple frequency spectra smaller in number than the total number of frequency spectra) among all of the frequency spectra stored in the storage unit 6 prior to the aforementioned sampling period, or may detect, as a re-detection specific peak, a specific peak from all of the frequency spectra stored in the storage unit 6 prior to the aforementioned sampling period. If the specific peak is to be detected as a re-detection specific peak from multiple frequency spectra, for example, the peak re-detector 24 may detect the re-detection specific peak sequentially and consecutively toward the past from the multiple frequency spectra. Alternatively, for example, the peak re-detector 24 may detect the re-detection specific peak non-consecutively toward the past from the multiple frequency spectra. In this embodiment, the peak re-detector 24 retrieves a predetermined number of frequency spectra, which are stored in the storage unit 6 respectively in association with a predetermined number of sampling periods prior to the aforementioned sampling period, sequentially and consecutively toward the past, and detects the re-detection specific peak sequentially and consecutively toward the past from the predetermined number of retrieved frequency spectra.

Normally, when some kind of failure that inhibits smooth rolling occurs in the rolling bearing in the normal state, a peak becomes determinable after the amplitude of the peak becomes large with the progress of the failure. Therefore, before a specific peak is detected by the peak detector 23, the frequency of the specific peak is unknown. For this reason, it is normally necessary to set the first frequency range FW1 to a relatively wide range. On the other hand, it is assumed that a specific peak prior to being identified has occurred in the vicinity of the identified frequency thereof. Therefore, a predetermined second frequency range that is smaller than the first frequency range FW1 and that includes the frequency of the specific peak is appropriately set in advance. For example, as shown in FIG. 4B, the second frequency range FW2 is set such that the frequency fp2 of the specific peak PK2 is the median frequency (fp2−Δfw2≤FW2≤fp2+Δfw2, Δfw2 being, for example, about 0.1% to 0.5% of the theoretical frequency ft).

In the detection of the re-detection specific peak, a peak with the maximum amplitude within the second frequency range FW2 and also having a peak existing at an integral multiple component of the frequency thereof is detected as the re-detection specific peak. For example, in FIG. 4B, a peak PK2′ with the maximum amplitude within the second frequency range FW2 and also having a peak existing at an integral multiple component of the frequency thereof is detected as the re-detection specific peak.

The second frequency range FW2 may be the same when detect a re-detection specific peak from each of multiple frequency spectra. In this embodiment, when the peak re-detector 24 is to detect the re-detection specific peak toward the past from the multiple frequency spectra, the peak re-detector 24 regards the peak detection process and a specific peak detected in the peak detection process with respect to each frequency spectrum as a first peak re-detection process and a first re-detection specific peak, respectively, and detects the re-detection specific peak in the second frequency range FW2, which includes a re-detection specific peak detected in one previous peak re-detection process, from the frequency spectrum. A re-detection specific peak can be detected even if the frequency of the re-detection specific peak is deviated due to, for example, wear.

After a specific peak is detected for the first time, the peak detector 23 may further detect the specific peak within the second frequency range FW2, which includes the peak PK2 detected for the first time, from the frequency spectrum stored in the storage unit 6 in the sampling period for every sampling period subsequent to the sampling period when the specific peak is detected. In this embodiment, the peak detector 23 further detects the specific peak within the second frequency range FW2, which includes a specific peak detected in one previous peak detection process of the sampling period, from the frequency spectrum stored in the storage unit 6 in the sampling period for every sampling period subsequent to the sampling period when the specific peak is detected. For example, a specific peak can be detected even if the frequency of the specific peak is deviated due to, for example, wear.

The timing predictor 25 executes a replacement-timing prediction process involving predicting a replacement timing of each rolling bearing based on a sampling period when a specific peak is detected by the peak detector 23 as well as the amplitude of the detected specific peak, and based on a sampling period when a re-detection specific peak detected by the peak re-detector 24 and the amplitude of the detected re-detection specific peak.

When the peak re-detector 24 detects a single re-detection specific peak by using a single frequency spectrum, the timing predictor 25 predicts the replacement timing based on a specific peak detected by the peak detector 23 and the single re-detection specific peak detected by the peak re-detector 24. When the peak re-detector 24 detects multiple re-detection specific peaks by using multiple frequency spectra, the timing predictor 25 predicts the replacement timing based on a specific peak detected by the peak detector 23 and the multiple re-detection specific peaks detected by the peak re-detector 24. In a sampling period subsequent to when a specific peak is detected for the first time by the peak detector 23, the timing predictor 25 predicts the replacement timing based on the specific peak detected for the first time, the specific peak detected in the sampling period, and at least one re-detection specific peak. The timing predictor 25 outputs the predicted replacement timing to the output unit 4.

For example, in the example shown in FIG. 5, if the peak detector 23 detects a specific peak denoted by a solid circle at a timing TD₀ of a sampling period (e.g., a central time point TD₀ serving as a representative time point of the sampling period), the peak re-detector 24 detects a re-detection specific peak within the second frequency range FW2, which includes the specific peak denoted by the solid circle, from a frequency spectrum at a timing T_{D-1}, which is one timing prior to the timing TD₀, thereby detecting the re-detection specific peak denoted by, for example, “x” at the timing T_{D-1}. It is assumed that the detection is performed by retrieving four frequency spectra by tracing back toward the past. Then, the peak re-detector 24 detects a re-detection specific peak within the second frequency range FW2, which includes the re-detection specific peak x at the timing T_{D-1}, from a frequency spectrum at a timing TD₋₂, which is one timing prior to the timing T_{D-1}, thereby detecting the re-detection specific peak denoted by, for example, “x” at the timing TD₋₂. Subsequently, the peak re-detector 24 detects a re-detection specific peak within the second frequency range FW2, which includes the re-detection specific peak x at the timing TD₋₂, from a frequency spectrum at a timing TD₋₃, which is one timing prior to the timing TD₋₂. In the example shown in FIG. 5, a peak is not detected from the frequency spectrum at the timing TD₋₃. Then, the peak re-detector 24 detects a re-detection specific peak within the second frequency range FW2, which includes the re-detection specific peak x at the timing TD₋₃, from a frequency spectrum at a timing TD₋₄, which is one timing prior to the timing TD₋₃. In the example shown in FIG. 5, a peak is not detected from the frequency spectrum at the timing TD₋₄. Subsequently, the timing predictor 25 predicts the replacement timing based on the specific peak denoted by the solid circle at the timing TD₀, the re-detection specific peak x at the timing T_{D-1}, and the re-detection specific peak x at the timing TD₋₂.

For example, in a coordinate space having time and amplitude set as coordinate axes, the timing predictor 25 determines a fitting curve that most fits the central time point of the sampling period and the amplitude of a specific peak as well as the central time point of the sampling period and the amplitude of a re-detection specific peak, and determines a time point, as a replacement timing, where the determined fitting curve intersects a preset criterion amplitude value used for determining the replacement timing. In the example shown in FIG. 5, the timing predictor 25 determines a fitting curve α that most fits the timing TD₀ and the amplitude of the specific peak denoted by the solid circle, the timing TD₋₁ and the amplitude of the re-detection specific peak x at the timing T_{D-1}, and the timing TD₋₂ and the amplitude of the re-detection specific peak x at the timing TD₋₂, and determines a time point ESα, as a replacement timing ESα, where the determined fitting curve α intersects a preset criterion amplitude value Th used for determining the replacement timing.

At a timing TD₊₁ subsequent to the timing TD₀, the peak detector 23 detects a specific peak at the timing TD₊₁ within the second frequency range FW2, which includes the specific peak denoted by the solid circle at the timing TD₀, from a frequency spectrum at the timing TD₊₁, thereby detecting the specific peak denoted by, for example, “x” at the timing TD₊₁. Then, the timing predictor 25 predicts the replacement timing based on the specific peak denoted by the solid circle at the timing TD₀, the specific peak at the timing TD₊₁, and the re-detection specific peaks at the respective timings TD₋₁ and TD₋₂.

Alternatively, for example, when the peak detector 23 detects the specific peak denoted by the solid circle at the timing TD₀, the peak re-detector 24 detects a re-detection specific peak within the second frequency range FW2, which includes the specific peak denoted by the solid circle, from the frequency spectrum at the timing T_{D-1}, which is one timing prior to the timing TD₀, thereby detecting the re-detection specific peak denoted by, for example, a hollow circle “o” at the timing T_{D-1}. Then, the peak re-detector 24 detects a re-detection specific peak within the second frequency range FW2, which includes the re-detection specific peak o at the timing T_{D-1}, from the frequency spectrum at the timing TD-3, which is one timing prior to the timing T_{D-1}, thereby detecting the re-detection specific peak denoted by, for example, a hollow circle “o” at the timing TD₋₃. Subsequently, the peak re-detector 24 detects a re-detection specific peak within the second frequency range FW2, which includes the re-detection specific peak o at the timing TD₋₂, from the frequency spectrum at the timing TD₋₃, which is one timing prior to the timing TD₋₂, thereby detecting the re-detection specific peak denoted by, for example, a hollow circle “o” at the timing TD₋₃. Then, the peak re-detector 24 detects a re-detection specific peak within the second frequency range FW2, which includes the re-detection specific peak o at the timing TD₋₃, from the frequency spectrum at the timing TD₋₄, which is one timing prior to the timing TD₋₃, thereby detecting the re-detection specific peak denoted by, for example, a hollow circle “o” at the timing TD₋₄. Subsequently, the timing predictor 25 predicts the replacement timing based on the specific peak denoted by the solid circle at the timing TD₀, and the re-detection specific peaks o at the respective timings T_{D-1}, TD₋₂, TD₋₃, and TD₋₄. For example, similar to the above, the timing predictor 25 determines a fitting curve β that most fits the timing TD₀ and the amplitude of the specific peak denoted by the solid circle, as well as the timings T_{D-1}, TD₋₂, TD₋₃, and TD₋₄ and the amplitudes of the re-detection specific peaks at the respective timings T_{D-1}, TD₋₂, TD₋₃, and TD₋₄, and determines a time point ESβ, as a replacement timing ESβ, where the determined fitting curve β intersects the criterion amplitude value Th.

At the timing TD₊₁ subsequent to the timing TD₀, the peak detector 23 detects a specific peak at the timing TD₊₁ within the second frequency range FW2, which includes the specific peak denoted by the solid circle at the timing TD₀, from the frequency spectrum at the timing TD₊₁, thereby detecting the specific peak denoted by, for example, a hollow circle “o” at the timing TD₊₁. Then, the timing predictor 25 predicts the replacement timing based on the specific peak denoted by the solid circle at the timing TD₀, the specific peak o at the timing TD₊₁, and the re-detection specific peaks o at the respective timings T_{D-1}, TD₋₂, TD₋₃, and TD₋₄.

At a timing TD₊₂ subsequent to the timing TD₀, the peak detector 23 detects a specific peak at the timing TD₊₂ within the second frequency range FW2, which includes the specific peak o at the timing TD₊₁, from a frequency spectrum at the timing TD₊₂, thereby detecting the specific peak denoted by, for example, a hollow circle “o” at the timing TD₊₂. Then, the timing predictor 25 predicts the replacement timing based on the specific peak denoted by the solid circle at the timing TD₀, the specific peaks o at the respective timings TD₊₁ and TD₊₂, and the re-detection specific peaks o at the respective timings T_{D-1}, TD₋₂, TD₋₃, and TD₋₄.

Likewise, at a timing TD₊₃ subsequent to the timing TD₀, the peak detector 23 detects a specific peak at the timing TD₊₃ within the second frequency range FW2, which includes the specific peak o at the timing TD₊₂, from a frequency spectrum at the timing TD₊₃, thereby detecting the specific peak denoted by, for example, a hollow circle “o” at the timing TD₊₃. Then, the timing predictor 25 predicts the replacement timing based on the specific peak denoted by the solid circle at the timing TD₀, the specific peaks o at the respective timings TD₊₁, TD₊₂, and TD₊₃, and the re-detection specific peaks o at the respective timings T_{D-1}, TD₋₂, TD₋₃, and TD₋₄.

In the example shown in FIG. 5, in the case of the specific peak denoted by the solid circle and the re-detection specific peaks x, the failure progresses relatively quickly, the remaining lifespan from the timing TD₀ is relatively short, and the predicted replacement timing ESα has the progress (i.e., temporal change or trend) of the failure reflected thereon. On the other hand, in the case of the specific peak denoted by the solid circle and the re-detection specific peaks o, the failure progresses relatively slowly, the remaining lifespan from the timing TD₀ is relatively long, and the predicted replacement timing ESβ has the progress (i.e., temporal change or trend) of the failure reflected thereon (ESα<ESβ). Accordingly, even when the timing TD₀ at which the specific peak denoted by the solid circle is detected is the same, the remaining lifespan varies if the progress of the failure is different, so that the replacement timing also varies. The rolling-bearing replacement-timing prediction device 1000 according to this embodiment can predict the replacement timing in view of the progress of the failure.

The control processor 2, the input unit 3, the output unit 4, the IF unit 5, and the storage unit 6 can be constituted by, for example, a computer of a desktop type or a notebook type.

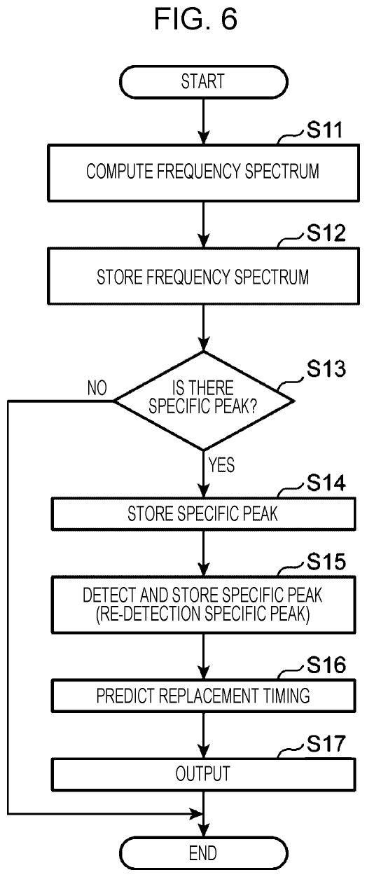

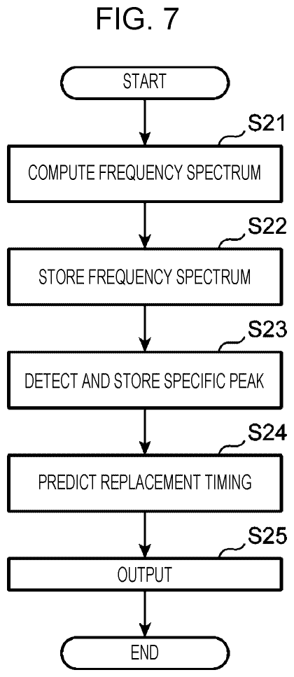

Next, the operation according to this embodiment will be described. FIG. 6 is a flowchart illustrating the operation of the rolling-bearing replacement-timing prediction device before detecting a specific peak. FIG. 7 is a flowchart illustrating the operation of the rolling-bearing replacement-timing prediction device after detecting the specific peak.

When the power of the rolling-bearing replacement-timing prediction device 1000 having the above configuration is turned on, the rolling-bearing replacement-timing prediction device 1000 executes initialization of required components and starts to operate. The control processor 2 executes the control processing program to functionally serve as the controller 21, the spectrum processor 22, the peak detector 23, the peak re-detector 24, and the timing predictor 25.

Referring to FIG. 6, when the operation starts and the start timing of a sampling period is reached, the rolling-bearing replacement-timing prediction device 1000 first causes the spectrum processor 22 of the control processor 2 to acquire, from the storage unit 6, vibration data acquired by each of the first to third vibration detection sensors 1-1 to 1-3 in the duration TW of the sampling period so as to determine a frequency spectrum of the vibration data in the current sampling period in step S11, and stores the determined frequency spectrum in association with the current sampling period into the storage unit 6 in step S12.

Subsequently, the rolling-bearing replacement-timing prediction device 1000 causes the peak detector 23 of the control processor 2 to detect a specific peak within the predetermined first frequency range, which includes the theoretical frequency, from the frequency spectrum in the current sampling period in step S13. If the detection result indicates that there is no specific peak detected (NO), the rolling-bearing replacement-timing prediction device 1000 ends the process in the current sampling period. In contrast, if the detection result indicates that there is a specific peak detected (YES), the rolling-bearing replacement-timing prediction device 1000 subsequently executes step S14.

In step S14, the rolling-bearing replacement-timing prediction device 1000 causes the peak detector 23 of the control processor 2 to store the detected specific peak (and the sampling period, amplitude, and frequency thereof) into the storage unit 6.

Then, the rolling-bearing replacement-timing prediction device 1000 causes the peak re-detector 24 of the control processor 2 to detect a specific peak as a re-detection specific peak and to store the detected re-detection specific peak (and the sampling period, amplitude, and frequency thereof) into the storage unit 6 in step S15.

Subsequently, the rolling-bearing replacement-timing prediction device 1000 causes the timing predictor 25 of the control processor 2 to predict the replacement timing of each rolling bearing BE based on the specific peak and the re-detection specific peak in step S16.

Then, the rolling-bearing replacement-timing prediction device 1000 causes the timing predictor 25 to output the predicted replacement timing to the output unit 4 in step S17, and ends the process in the current sampling period. The replacement timing may be output to an external device via the IF unit 5, where necessary.

On the other hand, referring to FIG. 7, when a sampling period subsequent to the detection of the specific peak is reached, the rolling-bearing replacement-timing prediction device 1000 first causes the spectrum processor 22 of the control processor 2 to determine a frequency spectrum of the vibration data in the current sampling period in step S21, similarly to step S11 described above, and stores the determined frequency spectrum in association with the current sampling period into the storage unit 6 in step S22, similarly to step S12 described above.

Subsequently, the rolling-bearing replacement-timing prediction device 1000 causes the peak detector 23 of the control processor 2 to detect a specific peak in the current sampling period, and stores the detected specific peak (and the sampling period and the amplitude thereof) into the storage unit 6 in step S23.

Then, the rolling-bearing replacement-timing prediction device 1000 causes the timing predictor 25 of the control processor 2 to predict the replacement timing of each rolling bearing BE based on the specific peaks and the re-detection specific peaks detected up to this point in step S24.

Subsequently, the rolling-bearing replacement-timing prediction device 1000 causes the timing predictor 25 to output the predicted replacement timing to the output unit 4 in step S25, similarly to step S17 described above, and ends the process in the current sampling period.

As described above, in the rolling-bearing replacement-timing prediction device 1000 according to the embodiment and a rolling-bearing replacement-timing prediction method implemented therein, a specific peak is detected within the first frequency range FW1 including the theoretical frequency, so that the specific peak can be detected more reliably. A specific peak is re-detected by narrowing down to the second frequency range that is smaller than the first frequency range, so that a misleading peak that is included in the first frequency range but does not cause the failure to occur is excluded from a detection target, thereby enabling more reliable detection of a specific peak that causes the failure to occur.

After a peak is identified, a remaining lifespan as a time period until the rolling bearing needs to be replaced ((end point of a sampling period corresponding to a frequency spectrum (vibration data) in which the specific peak is detected)+(remaining lifespan at that time)=(replacement timing)) is dependent on the progress (i.e., temporal change or trend) of the failure. In the rolling-bearing replacement-timing prediction device 1000 and the rolling-bearing replacement-timing prediction method described above, not only a specific peak but also a re-detection specific peak prior thereto are detected, and the replacement timing is predicted based on the sampling period when the specific peak is detected as well as the amplitude of the detected specific peak, and based on the sampling period when the re-detection specific peak is detected as well as the amplitude of the detected re-detection specific peak, so that the replacement timing is predicted in view of the progress of the failure, whereby the replacement timing can be predicted more accurately. Furthermore, in the rolling-bearing replacement-timing prediction device 1000 and the rolling-bearing replacement-timing prediction method described above, if the replacement timing is predicted by using multiple re-detection specific peaks, the replacement timing can be predicted more accurately, as compared with a case where the replacement timing is predicted by using a single re-detection specific peak.

In the rolling-bearing replacement-timing prediction device 1000 and the rolling-bearing replacement-timing prediction method described above, a re-detection specific peak is detected within the second frequency range including a re-detection specific peak detected in one previous peak re-detection process, so that the re-detection specific peak can be detected more reliably even when the frequency of the re-detection specific peak changes with time.

In the rolling-bearing replacement-timing prediction device 1000 and the rolling-bearing replacement-timing prediction method described above, a specific peak is detected within the second frequency range including a specific peak detected in one previous peak detection process, so that the specific peak can be detected more reliably even when the frequency of the specific peak changes with time. In the rolling-bearing replacement-timing prediction device 1000 and the rolling-bearing replacement-timing prediction method described above, the replacement timing is predicted by also using a specific peak in a sampling period subsequent to the sampling period when the specific peak is detected, so that the replacement timing can be predicted more accurately.

In the above embodiment, a data logger 7 may be provided between the vibration detection sensor 1 and the control processor 2, and the spectrum processor 22 may be provided in the data logger 7.

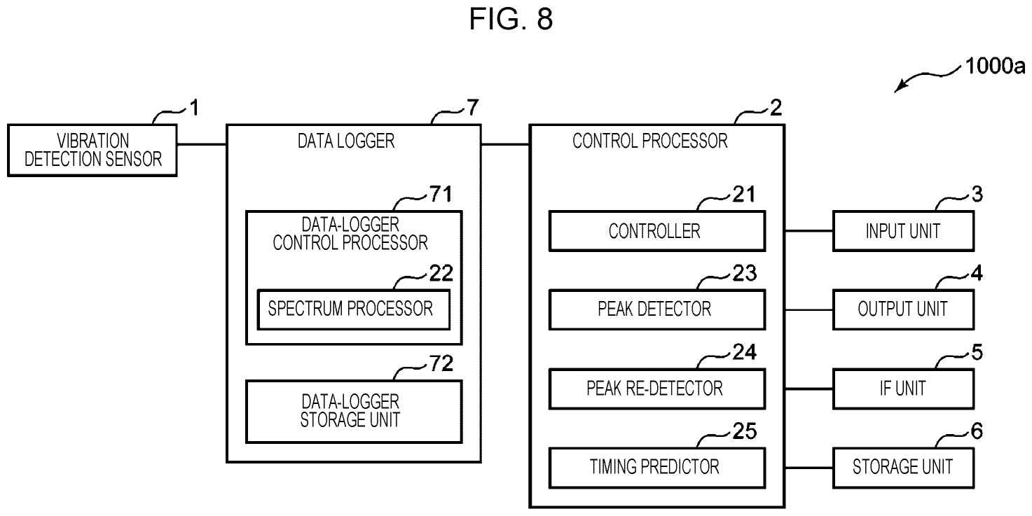

FIG. 8 is a block diagram illustrating the configuration of a rolling-bearing replacement-timing prediction device according to a modification of the embodiment. For example, as shown in FIG. 8, a rolling-bearing replacement-timing prediction device 1000a according to this modification includes the vibration detection sensor 1, the data logger 7, the control processor 2, the input unit 3, the output unit 4, the IF unit 5, and the storage unit 6.

Descriptions of the vibration detection sensor 1, the control processor 2, the input unit 3, the output unit 4, the IF unit 5, and the storage unit 6 in the rolling-bearing replacement-timing prediction device 1000a will be omitted since they are respectively similar to the vibration detection sensor 1, the control processor 2, the input unit 3, the output unit 4, the IF unit 5, and the storage unit 6 in the rolling-bearing replacement-timing prediction device 1000 except for the fact that the function of the control processor 2 and the function of the storage unit 6 are partially relocated to the data logger 7. The control processor 2 functionally includes the controller 21, the peak detector 23, the peak re-detector 24, and the timing predictor 25, and the spectrum processing function is relocated to the data logger 7. The function for storing vibration data and the frequency spectrum thereof is relocated to the data logger 7.

The data logger 7 is connected to each of the vibration detection sensor 1 and the control processor 2, is constituted by including, for example, a computer, and includes a data-logger control processor 71 and a data-logger storage unit 72. The data-logger control processor 71 includes a CPU and a peripheral circuit thereof, and functionally includes the spectrum processor 22 functioning similarly to the above except for storing data into the data-logger storage unit 72 in place of the storage unit 6. The data-logger storage unit 72 includes a ROM, an EEPROM, a RAM, and a hard disk drive, and stores the vibration data and the frequency spectrum. The data logger 7 outputs the frequency spectrum of the vibration data to the control processor 2 in accordance with a request from the control processor 2.

Although the present disclosure has been appropriately and sufficiently described above with reference to the embodiment by referring to the drawings in order to express the present disclosure, it should be recognized that a skilled person can readily modify and/or alter the above embodiment. Therefore, it is to be interpreted that a modification or an alteration implemented by a skilled person is included in the scope of the claims so long as the modification or the alteration does not depart from the scope of the claims.

What is claimed is:

1. A rolling-bearing replacement-timing prediction method comprising:
a spectrum processing step for acquiring vibration data, which indicates vibration occurring in a rolling bearing, in a predetermined sampling period at every predetermined acquisition interval, determining a frequency spectrum of the vibration data in the sampling period with respect to the vibration data, and storing the determined frequency spectrum in association with the sampling period into a storage unit;
a peak detection step for detecting, from the frequency spectrum, a specific peak not appearing during a normal state of the rolling bearing within a predetermined first frequency range including a theoretical frequency that brings about a peak in the frequency spectrum when an abnormality occurs;
a peak re-detection step for detecting, if the specific peak is detected in the peak detection step, a specific peak not appearing during the normal state of the rolling bearing as a re-detection specific peak within a predetermined second frequency range from at least one frequency spectrum stored in the storage unit prior to a sampling period when the specific peak is detected, the predetermined second frequency range including a frequency of the specific peak detected in the peak detection step and being smaller than the first frequency range; and
a replacement-timing prediction step for predicting a replacement timing of the rolling bearing based on the sampling period when the specific peak is detected in the peak detection step as well as an amplitude of the detected specific peak, and based on a sampling period when the re-detection specific peak is detected in the peak re-detection step as well as an amplitude of the detected re-detection specific peak.

2. The rolling-bearing replacement-timing prediction method according to claim 1,
wherein the at least one frequency spectrum comprises a plurality of frequency spectra, and
wherein the peak re-detection step comprises, when detecting the re-detection specific peak in a past direction from the plurality of frequency spectra, regarding the peak detection step and the specific peak detected in the peak detection step with respect to each frequency spectrum as a first peak re-detection step and a first re-detection specific peak, respectively, and detecting, from the frequency spectrum, the re-detection specific peak within the second frequency range including a re-detection specific peak detected in one previous peak re-detection step.

3. The rolling-bearing replacement-timing prediction method according to claim 1,
wherein the peak detection step further comprises detecting the specific peak within the second frequency range, which includes a specific peak detected in one previous peak detection step of the sampling period, from the frequency spectrum stored in the storage unit in the sampling period for every sampling period subsequent to the sampling period when the specific peak is detected.

4. The rolling-bearing replacement-timing prediction method according to claim 1,
wherein a duration of the sampling period is set based on the second frequency range, and
wherein the sampling period is set to a longer period as the second frequency range becomes smaller.

5. A rolling-bearing replacement-timing prediction device comprising:
a vibration detection sensor that acquires vibration data indicating vibration occurring in a rolling bearing;
a storage unit; and
a control processor that performs spectrum processing, a peak detection process, a peak re-detection process, and a replacement-timing prediction process;
wherein the spectrum processing comprises acquiring the vibration data in a predetermined sampling period at every predetermined acquisition interval, determining a frequency spectrum of the vibration data in the sampling period with respect to the vibration data in the sampling period, and storing the determined frequency spectrum in association with the sampling period into the storage unit,
wherein the peak detection process comprises detecting, from the frequency spectrum, a specific peak not appearing during a normal state of the rolling bearing within a predetermined first frequency range including a theoretical frequency that brings about a peak in the frequency spectrum when an abnormality occurs;
wherein the peak re-detection process comprises, if the specific peak is detected in the peak detection process, detecting a specific peak not appearing during the normal state of the rolling bearing as a re-detection specific peak within a predetermined second frequency range from at least one frequency spectrum stored in the storage unit prior to a sampling period when the specific peak is detected, the predetermined second frequency range including a frequency of the specific peak detected in the peak detection process and being smaller than the first frequency range; and
wherein the replacement-timing prediction process comprises predicting a replacement timing of the rolling bearing based on the sampling period when the specific peak is detected in the peak detection process as well as an amplitude of the detected specific peak, and based on a sampling period when the re-detection specific peak is detected in the peak re-detection process as well as an amplitude of the detected re-detection specific peak.
